(19) United States
(12) Patent Application Publication
(10) Pub. No.: US 2008/0061945 A1
(43) Pub. Date: Mar. 13, 2008

(54) CONTACTLESS DATA COMMUNICATION SYSTEM AND CONTACTLESS IC TAG

(75) Inventor: Masaki HOSHINA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/853,342

(22) Filed: Sep. 11, 2007

(30) Foreign Application Priority Data
Sep. 11, 2006 (JP) 2006-245167
Aug. 10, 2007 (JP) 2007-208973

(51) Int. Cl. H04B 7/00

(52) U.S. Cl. 340/10.51

(57) ABSTRACT

A contactless data communication system includes: a first and a second contactless integrated circuit tags each including an unique identifier; and a reader-writer for reading out and writing in data in a contactless state with the first and the second contactless integrated circuit tags. The first integrated circuit tag includes: a data detection unit for detecting data; a data determination unit for determining data detected by the data detection unit; and a data transmission unit for transmitting a determination result of the data determination unit to the second contactless integrated circuit tag. Here, the reader-writer and the first and the second contactless integrated circuit tags performing a contactless data communication therebetween, using an induction field; and the first contactless integrated circuit tag creating and electrical power from the induction field generated by the reader-writer, and the utilizing the electrical power so as to perform a contactless data communication with the second contactless integrated circuit tag.

The entire disclosure of Japanese Patent Application Nos. 2006-245167, filed Sep. 11, 2006 and 2007-208973, filed Aug. 10, 2007 are expressly incorporated by reference herein.

### BACKGROUND

1. Technical Field

Several aspects of the present invention relate to a contactless data communication system for carrying out contactless data communications between a contactless IC tag and a reader-writer using an induction field, as well as to a contactless IC tag used in such communication.

2. Related Art

It is known that contactless data communication systems utilize an induction filed for contactless data communications between a contactless IC tag adhered to a commodity and a reader-writer, so as to read an unique identification provided to the contactless IC tag. Such contactless communication systems are widely applied to systems such as an inventory management system for controlling commodity inventories and a logistics system for read/write history data in distribution phase.

The contactless data communication system is also used for a management of fluid containers. For instance, fluid containers which include contactless IC tags adhered to external walls thereof are suggested for identifying fluids contained in those containers. JP-A-2002-259934 is an example of related art. Moreover, in order to manage a plurality of containers for sealing drug discovery samples, a device that collectively carries out reading/writing of contactless IC tags adhered to the containers is disclosed (refer to JP-A-2005-351641). At the same time, since some contactless IC tags can be utilized in label printing, information related to the commodities is printed to labels by a command of a host system, and is also written into the contactless IC tags which are adhered to the commodities. JP-A-2002-207984 is an example of related art.

In case where the fluid inside the container is unknown, however, it is necessary to check and clarify the content of the container in advance. In addition, if the fluid is replaced, it is thereafter necessary to check every time what the fluid is, followed by the replacement of the contactless IC tag adhered to the container as well as the rewriting of the display of the label. In such case, the cost of the entire system increases, since it is time consuming to exchange the contactless IC tags in a distribution phase or a testing phase, and the amount of tags to be discarded increases.

Moreover, known systems do not include the option to determine whether or not the fluid in the container and the display of the contactless IC tag adhered to the container really matches. Thus, in case the fluid is replaced, it is necessary to perform more strict content confirmation for the safety; so that there is no mismatch between the actual fluid and the display thereof.

Still further, the communication range becomes short between the contactless IC tag and the reader-writer, when fluids are contained inside the containers, therefore requiring to remake the internal structure of the contactless IC tag into a specific packaging structure, also resulting in cost increase.

### SUMMARY

An advantage of the invention is to provide a contactless data communication system which allows a cost reduction of the entire system without requiring time for exchanging the contactless IC tags in a distribution phase or a testing phase, and without increasing the number of tags disposed.

Another advantage of the invention is to provide a contactless data communication system which increases the credibility of the displayed contents, so that the display of the contactless IC tag adhered to the container and the fluid contained therein always matches, even after the fluid is replaced.

Another advantage of the invention is to provide a contactless data communication system at low cost, without involving the remaking of the internal structure of the contactless IC tag into a specific packaging structure, even when the communication range between the contactless IC tag and the reader-writer is short.

Yet another advantage of the invention is to provide a novel contactless IC tag suitably used for such contactless data communication system.

According to a first aspection of the invention, a contactless data communication system includes: a first and a second contactless integrated circuit tags each including an unique identifier; and a reader-writer for reading out and writing in data in a contactless state with the first and the second contactless integrated circuit tags. The first integrated circuit tag includes: a data detection unit for detecting data; a data determination unit for determining data detected by the data detection unit; and a data transmission unit for transmitting a determination result of the data determination unit to the second contactless integrated circuit tag. Here, the reader-writer and the first and the second contactless integrated circuit tags performing a contactless data communication therebetween, using an induction field; and the first contactless integrated circuit tag creating an electrical power from the induction field generated bay the reader-writer, and utilizing the electrical power so as to perform a contactless data communication with the second contactless integrated circuit tag.

In such contactless data communication system, the data determination unit determines the data detected by the detection unit of the first contactless IC tag, and the determination result is transmitted to the second contactless IC tag through the data transmission unit. At this time, the first contactless IC tag creates an electrical power from an induction field generated by the reader-writer, and communicates with the second contactless IC tag by utilizing this electrical power. Thereafter, the second contactless IC tag receives the data transmitted through the data receiving unit from the first contactless IC tag, and carries out a display with the display unit based on that received data.

Therefore, in this contactless data communication system, what is displayed in the display unit can be rewritable without exchanging the contactless IC tag. This allows a cost reduction of the entire system, eliminating time of the contactless IC tag replacement in the logistics phase or checking phase, with no increase in the number of tags discharged.

Further, the credibility of the display contents can be increased, since what has been detected in the detection unit in the first contactless IC tag is displayed in the display unlit of the second contactless IC tag.

Moreover, there is no need to remake the internal structure of the contactless IC tag into a specific packaging structure, even when the communication range is short between the contactless IC tag and the reader-writer is short. The cost increase of the system may thereby be prevented.

In this case, the data detection unit of the contactless data communication system includes a sensor for detecting a fluid accommodated in a container, and the data determination unit determines a type of the fluid based on a data detected by the sensor.

Such contactless data communication system increases the credibility of the displayed contents, in order for the display of the contactless IC tag adhered to the container to always match the fluid contained therein, even after the fluid is replaced, thereby improving the safety of the user handling the containers.

In this case, the first contactless integrated circuit is arranged at an internal side of the container, and the second contactless integrated circuit tag is arranged at an external side of the container.

In this contactless data communication system, the first contactless IC tag arranged inside the container creates an electrical power from an induction field generated by the reader-writer, and communicates with the second contactless IC tag arranged outside the container by utilizing this electrical power.

In this case, during the communication of the first contactless integrated circuit tag with the second integrated circuit tag, the reader-writer considers that a function of the second contactless integrated circuit tag is added to the first integrated circuit tag.

Moreover, in this case, the second contactless integrated circuit tag includes a data processing unit for conducting a specific processing based on data transmitted from the first contactless integrated circuit tag. Here, the contactless data communication system is produced including the plurality of second contactless integrated circuit tags, each performing a different specific processing, so that the second contactless integrated circuit tag may be exchanged in accordance with the desired specific processing.

Further in this case, the second integrated circuit tag allows a registration of unique identifiers for a plurality of first contactless integrated circuit tags, and conducts a display in the display unit, using data transmitted from the plurality of first contactless integrated circuit tags having the unique identifiers registered therein. For instance, when containers are stored one after the other, this system enables the display in the display unit of one container positioned in the front, based on the data transmitted from the first contactless IC tag installed on another container positioned in the back.

This contactless data communication system virtually adds a functionality to contactless IC tags, or, in other words, the first contactless IC tag and the second contactless IC tag are seen as if they are integrated by using therebetween the contactless communication. Moreover, this contactless data communication system may reduce the cost of contactless IC tags, since the functionality of the contactless IC tags can be added or modified without providing in advance a plurality of functionalities to those contactless IC tags.

According to a second aspect of the invention, a contactless integrated circuit tag includes: an unique identifier registered therein; a reader-writer; a data detection unit for detecting data; a data determination unit for determining data detected by the data detection unit; and a data transmission unit for transmitting a determination result of the data determination unit to another contactless integrated circuit tag. Here, the contactless integrated circuit tag creates an electrical power from an induction field generated by the reader-writer, and utilizes the electrical power so as to perform a contactless data communication with at least one of the reader/writer and another contactless integrated circuit tag.

In this contactless IC tag, the data determination unit determines the data detected by the detection unit, so that the determination result is transmitted to another contactless IC tag through the data transmission unit.

According to a third aspect of the invention, a contactless integrated circuit tag includes: an unique identifier registered therein; a reader-writer; a data receiving unit for receiving data transmitted from at least one of the reader-writer and another contactless integrated circuit tag; and a display unit which coducts a display based on data received by the data receiving unit. Here, the contactless integrated circuit tag creates an electrical power from an induction field generated by the reader-writer, and utilizes the electrical power so as to perform a contactless data communication with at least one of the reader/writer and another contactless integrated circuit tag.

In this contactless IC tag, communications transmitted from the reader-writer or another contactless IC tag is displayed in the display unit. Therefore, what is displayed in the display unit can be rewritten.

In this case, the display unit of the contactless IC tag may include a display device with a memory capability, retaining the display in a no-power state.

Such contactless IC tag can retain what is displayed in the display unit in a no-power state, and the display contents are not re-written, thereby increasing the credibility thereof.

### BRIEF DESCRIPTION OF THE DRAWINGS

The invention will be described with reference to the accompanying drawings, wherein like numbers reference like elements.

FIG. 1 is a block diagram illustrating an example of a composition of a contactless data communication system.

FIG. 2 is a block diagram illustrating an example of a reader-writer.

FIG. 3 is a block diagram illustrating an example of a contactless IC tag.

FIG. 4 is a perspective top view illustrating a structure of the contactless IC tag.

FIGS. 5A to 5D illustrate data frames being communicated between the reader-writer and the contactless IC tag.

FIG. 6 is a flow chart illustrating the processing of a sensing request command performed by the reader-writer.

FIG. 7 is a flow chart illustrating the response processing of a sensing request command performed by the contactless IC tag.

FIG. 8 is a flow chart illustrating the response processing of a display command performed by the contactless IC tag.

FIG. 9 is a flow chart illustrating the response processing of the sensing request command performed by the contactless IC tag.

### DESCRIPTION OF EXEMPLARY EMBODIMENTS

Embodiments of the invention will now be described in detail with references to the accompanying drawings.

The contactless data communication system to which the embodiments of the invention are applied is a radio frequency identification (RFID) system that uses radio-electromagnetic waves as a communication media. This system includes three characteristics: (1) the contactless IC tags are easy to carry; (2) the contactless IC tags store information in electric circuits; (3) the contactless IC tags intercommunicate in a contactless communication.

This means that the contactless data communication system is used in order for things such as a person, an object, or a car that are equipped with contactless IC tags to be unified with the information thereof. That is to say, a person, an object, or a car retrieves, as needed, necessary information from a contactless IC tag in a given place. At the same time, new information is written into a contactless IC tag if required.

Four typical methods used for contactless data communication systems include an electromagnetic coupling, an electromagnetic induction, a microwave method and an optical method.

The electromagnetic coupling method mainly utilizes a mutual induction of coils caused by the alternate current magnetic field for the communication of the contactless IC tags.

The electromagnetic induction method utilizes mainly long/middle range microwaves of 250 kHz or less, or of a 13.56 MHz band for the communication of the contactless IC tags.

The microwave method carries out the communication between an antenna 2h of the reader-writer 2 and the contactless IC tag 7, utilizing a microwave of a 2.4 GHz band.

In the optical method, an LED and a device such as a phototransistor are arranged as a light source and a receiver, and an optical space transmission is used for conducting the communication with the contactless IC tag.

The access method mainly includes four modes; a single access mode, a first-in first-out (FIFO) access mode, a multi access mold, and a selective access mode. In the single access mode, a single contactless IC tag is present within a domain of an antenna communication. If a number of contactless IC tags 7 are present in the domain, a communication error occurs such that the communication cannot be performed.

The FIFO access mode allows sequential communications with the contactless IC tag that enters the antenna communication domain. The contactless IC tag that completed its communication is provided with an access prohibition, so that even if a number of contactless IC tags 7 that completed their communication are present in the antenna communication domain, one new contactless IC tag entering the antenna communication domain can conduct the communication. If two or more contactless IC tags simultaneously enter the communication domain, the communication error occurs and therefore the communication cannot be performed.

In the multi-access mode, even when a number of contactless IC tags are present in the antenna communication domain, the communication can be performed with all the contactless IC tags.

The selective access mode allows communication with a specific contactless IC tag among the plurality of contactless IC tags that are present in the communication domain. Such communication is executed with a command for assigning numbers to the contactless IC tags present in the communication domain as well as with a command for conducting communication with the specific contactless IC tag based on the assigned number.

The contactless IC tags are used in an radio frequency identification (RFID) system, and are generally called a data carrier. The data carrier may have various shapes, such as shapes of a label, a card, a coin, and a stick.

These shapes have a close relation to applications. For instance, the tags carried by a person may have a key holder shape formed by fabricating a tag with the shape of a card or a label. Further, a shape of a stick is widely used for a carrier ID of a semiconductor, and a shape of a coin is the widely used for tags tacked to linen related clothes.

The contactless IC tags have storage regions for reading only, or, for reading and writing data. In addition, some contactless identification tags can operate without a battery, through contactless power transfer from the reader-writer.

### First Embodiment

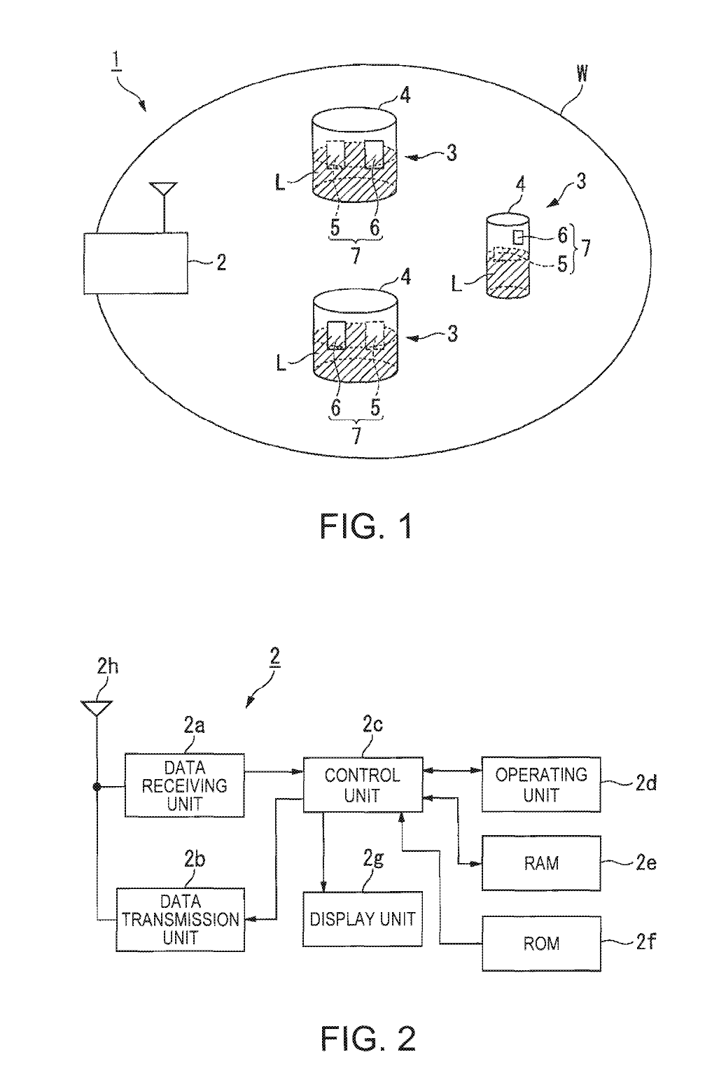

The first embodiment of the invention will now be described with reference to FIGS. 1 through 8.

FIG. 1 is a block diagram showing the structure of a contactless data communication system 1 according to the embodiments of the invention.

This contactless data communication system 1 includes, as shown in FIG. 1, a reader-writer 2, and a plurality of contactless IC tags 3. The contactless data communication is performed therebetween, utilizing an induction field W.

Further, this contactless data communication system 1 includes a first contactless IC tag 5 (hereafter referred to as “internal tag 5”) that is adhered to the inside of a container 4, and a second contactless IC tag 6 (hereafter referred to as “external tag 6”) that is adhered to the outside the container 4. The internal tag 5 includes a biosensor for detecting a solution L accommodated in the container 4, and the external tag 6 includes a display device which allows nonvolatile display for displaying the type of the solution L accommodated in the container 4. In the description below, the internal tag 5 and the external tag 6 are combined and treated as a contactless IC tag 7, and the contactless IC tag 7 may include a plurality of contactless IC tags 7.

FIG. 2 is a block diagram illustrating the structure of the reader-writer 2.

The reader-writer 2 reads out or writes in data to the contactless IC tag 7 in a contactless state. Referring to FIG. 2, the reader-writer 2 includes a data receiving unit 2a, a data transmission unit 2b, a control unit 2c, an operating unit 2d, random access memory (RAM) 2e, read only memory (ROM) 2f, a display unit 2g, and the antenna 2h.

The data receiving unit 2a receives information from the contactless IC tag 7 in a contactless state. The data receiving unit 2a can thereby obtain information units such as administrative information related to the solution L.

The data transmission unit 2b transfers information units to the contactless IC tag 7 in a contactless state. Examples of information units include: commands to read in what is stored in the contactless IC tag 7 such as administrative information; and the administrative information that correlates the contactless IC tags 7 to commodities. In this embodiment, carrier waves for data communication are utilized as a power supply of the contactless IC tag 7.

This embodiment employs the electromagnetic induction method for the data communication between the reader-writer 2 and the contactless IC tag 7, mainly utilizing the long/middle range microwaves of 250 kHz and less, or, a 13.56 MHz band. In the data communication between the reader-writer 2 and the contactless IC tag 7, the selective access mode is employed, allowing communications with a specific contactless IC tag 7 among the plurality of contactless IC tags 7 that are present in the communication domain.

The control unit 2c controls the operations of the reader-writer 2, by executing a control program stored in the ROM 2f in an un-illustrated central processing unit (CPU). The following operations are controlled: the processing of the electromagnetic induction data communication between the data receiving unit 2a and the data transmission unit 2b, such as a data reception from the contactless IC tag 7 and a data transmission to the contactless IC tag 7; the modification processing of a setting used for the execution of the control program, in accordance with the operations in the operating unit 2d; and the display processing for displaying in the display unit 2g the predetermined information such as information obtained from the contactless IC tag 7.

The operating unit 2d is provided with: operational functionalities such as power-on, power-off, and switching for performing a program reset; and a configuration unit of information written into the contactless IC tag 7.

The RAM 2e is a memory unit for temporally storing the data necessary for the CPU of the control unit 2c to execute the control programs stored in the ROM 2f.

The ROM 2f is nonvolatile memory which stores control programs for controlling the reader-writer 2 and UIDs of the test containers and of the contactless IC tag 7 adhered thereto. This nonvolatile memory is formed with one of EEPROM, FeRAM, and FLASH.

The display unit 2g includes a display region such as a liquid crystal display; and is provided with functionalities for displaying the information obtained from the contactless IC tag 7, a current configuration of the reader-writer 2, and an execution status of the processing.

The antenna 2h transmits electromagnetic waves that contain data, from the reader-writer 2 to the contactless IC tag 7.

The reader-writer 2 with above structure sends a command to the internal tag 5 adhered to the container 4 so as to detect the solution L; writes in the information of the solution L to the external tag 6; reads out and displays in the display unit 2g the information written into the contactless TC tag 7; and displays in the display unit 2g the information to be transmitted to the contactless IC tag 7.

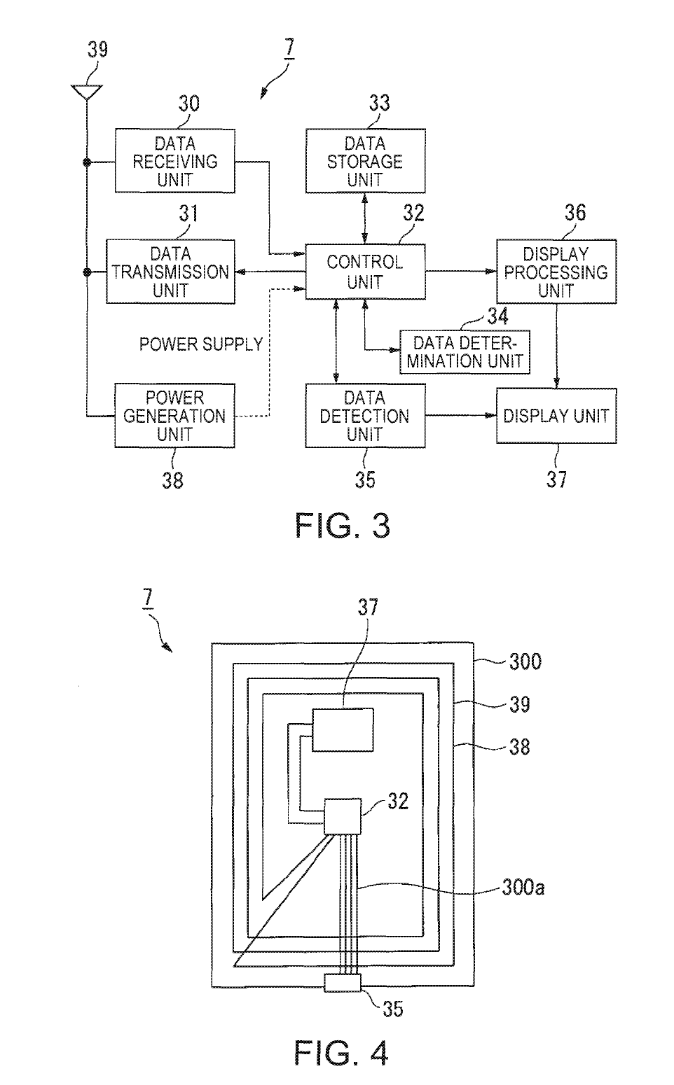

FIG. 3 is a block diagram illustrating the structure of the contactless IC tag 7.

As shown in FIG. 1, the contactless IC tag 7 corresponds one-on-one with the container 4, and conducts a contactless data communication with the reader-writer 2 using identification numbers, so as to manage the container 4. The identification numbers are unique to each contactless IC tag 7, and are stored in a data storage unit 33 described below.

The contactless IC tag 7 includes a data receiving unit 30, a data transmission unit 31, a control unit 32, a data storage unit 33, a data determination unit 34, a detection unit 35, a display processing unit 36 for display processing, a display unit 37, a power generation unit 38, and a coil antenna 39.

The contactless IC tag 7 does not necessarily include both the detection unit 35 and the display unit 37. However, the detection unit 35 must be mounted in the internal tag 5, and the display unit 37 must be mounted in the external tag 6.

The data receiving unit 30 is provided with a functionality to receive the data transferred from the reader-writer 2 with the electromagnetic induction method.

The data transmission unit 31 is provided with a functionality to transfer the predetermined data stored in the data storage unit 33, with the electromagnetic induction method, from the reader-writer 2 or directly from the internal tag 5 to the external tag 6. Load modulation signals are used for such communications.

The load modulation signal changes a parameter of an oscillation circuit of the contactless IC tag 7, when the coil of the coil antenna 39 is electromagnetically coupled due to the electromagnetic induction of the reader-writer 2 and the contactless IC tag 7, so as to change the impedance magnitude and the phase of the contactless IC tag 7. The reader-writer 2 detects the change in the impedance, and converts the change to a data unit to be transmitted from the contactless IC tag 7, with a conversion into “1” or “0”, depending on the presence of the data unit, so as to perform a contactless data transfer.

The load modulation signal transmitted from the contactless IC tag 7 to the reader-writer 2 is used as is in the direct transfer communication. Here, instead of setting the destination to the reader-writer 2, the destination is set to the contactless IC tag 7. However, if the direct transfer communication between different contactless IC tags 7 is carried out during the data transfer from the reader-writer 2, the signals from the two transfers overlap and cannot be read, since the contactless IC tag 7 present within the communication domain of the reader-writer 2 is load-modulated, based on a frequency such as 13.56 MHz, during the electromagnetic coupling with the reader-writer 2. Therefore, in the direct transfer communication, the reader-writer 2 does not transfer the data and maintain only the state of the electromagnetic coupling with the contactless IC tag 7. In this state, the load modulated signal is transmitted from the internal tag 5 to the external tag 6, so that the external tag 6 can read, at the data receiving unit 30, the data from the internal tag 5 as a change in the load modulation signal. By utilizing this mechanism, the data transfer between different contactless IC tags 7 is carried out utilizing the load modulation signal, without adding an additional receiving circuit for their communication.

The control unit 32 controls the operation of each unit in the contactless IC tag 7 by executing, with a non-illustrated CPU, the control programs corresponding to those units. In this embodiment, the system is configured so that the CPU and the control program modify the functionality of the contactless IC tag 7. However, the configuration is not limited thereto, and a logic circuit may also control these operations. Here, in the present embodiment, the control unit 32 includes the data determination unit 34 and the display processing unit 36.

The data storage unit 33 is provided with a functionality to store into its memory, corresponding to the command from the control unit 32, the predetermined data received from the reader-writer 2, such as administrative information. In this embodiment, the data storage unit 33 also stores the control programs described above. Moreover, the data storage unit 33 stores the access information from the reader-writer 2 to the contactless IC tag 7. The data storage unit 33 may be assembled in the control unit 32, or, attached externally. In this embodiment, the data storage unit 33 is assembled into the control unit 32, and is formed with any one of EEPROM, FLASH, and FeRAM.

The detection unit 35 includes a glucose sensor that detects an enzyme inside the solution L, so as to specify the solution L at the data determination unit 34. The glucose sensor is a typical biosensor, composed with any one of an electrode for detecting oxygen (oxygen electrode) and an electrode for detecting hydrogen peroxide, as well as with glucose oxidase which an enzyme fixed to the electrode. This glucose sensor detects whether or not the glucose is contained in the solution L, by detecting, with the electrode, the concentration of the hydrogen peroxide generated, or, the depreciation of oxygen consumed, when the glucose changes to gluconolactone in a catalyst reaction with the glucose oxidase, so as to measure the glucose concentration within the solution L.

Biosensors are sensors for realizing the functionalities biogenic bodies posses. Applications of the biosensors include sensors such as an enzyme sensor that uses a biogenic substance as a sensor, and sensors such as a taste sensor that imitates biogenic functions by using artificially produced materials. Common biosensors includes the enzyme sensor that detects materials such as glucose and urea by using the oxygen electrodes, and an immunosensor that detects antigen by using the antigen-antibody reaction. In a common detection method, a prescribed voltage is impressed to a biosensor, and the output of the sensor (i.e. a current or a voltage) is measured, so as to check if the output exceeds a certain threshold for a certain period of time, thereby determining the detection of enzyme and the like. In this embodiment, the enzyme sensor is installed on the detection unit 35 of the internal tag 5, for checking the presence of the enzyme that reacts to this enzyme sensor on the solution L. Either a single or plurality of enzyme sensors may be installed in the detection unit 35.

The display processing unit 36 is controlled by the control unit 32, so as to display a predetermined information in the display unit 37.

The display unit 37 is a display device which uses an electrophoresis phenomenon as an operational principal of an electrophoresis display device. Here, an electric filed is impressed onto a dispersed fluid, a resultant of which fine particles are dispersed in a liquid dispersion medium. As a result, electrophoresis particles, which are particles naturally charged by the dispersion, migrate with a coulomb force. Such electrophoresis display device has a display image retention capability (hereafter referred to as “memory capability”) and an image once displayed by impressing the electric field can be retained in a non-power state. Here, the display unit 37 displays the contents of the solution L determined at the data determination unit 34, or, may also indicate the contents of the solution L only with a color, different colors representing different contents, so as to differentiate the solution L by changing the display color in the display.

The power generation unit 38 generates the electric power from the electromagnetic wave received from the reader-writer 2, and supplies it to each unit described above.

The coil antenna 39 receives the electromagnetic wave that includes the data transmitted from the reader-writer 2, with the electromagnetic induction method.

FIG. 4 is a perspective top view illustrating a structure of the non-contact IC tag 7.

As shown in FIG. 4, the contactless IC tag 7 includes the coil antenna 39 that is formed with a metallic spiral line provided along the perimeter of a substrate 300. The substrate 300 is formed with a flexible material such as polyimide. The coil antenna 39 is formed, for instance, with an inkjet method or a screen printing method, using the metallic ink. The control unit 32 is packaged on the substrate 300 as an IC chip, and the display unit 37 is mounted as a display device with a memory capability. The control unit 32 is, as shown in FIG. 4, coupled with the detection unit 35 via an interconnection 300a. Even though this detection unit 35 is packaged on the substrate 300, it may also be installed outside the substrate 300, being coupled thereto via the interconnection 300a. In order to protect the circuit mounted to the substrate 300 from the external dust and the like, a protection such as a thin film is adhered to the circuit.

The contactless data, communication system 1 shown as the first embodiment is applied to a system in which the contactless IC tag 7 is adhered to the container 4 that contains the solution L, so as to specify the solution L. In this system, the contactless IC tag 7 detects and specifies the contents of the solution L which is displayed in the contactless IC tag 7, so as to manage the container 4 and the solution L.

Hereafter, a detailed operation of the contactless data communication system I will be described.

The contactless IC tag 7 is adhered in advance to the container 4 to which the solution L is to be accommodated. Thereafter, with the operating unit 2d of the reader-writer 2, the system is set so as to detect the solution L with the contactless IC tag 7 adhered to the container 4, and to display the detection result in the display unit 37.

The setting includes information such as: an ID number (hereafter referred to as “UID”) for specifying the internal tag 5 with the glucose sensor adhered inside the container 4; the UID) for specifying the external tag 6 with the display unit 37 adhered outside the container 4 which pairs with the internal tag 5; and the name of the operator.

The settings displayed in the display unit 2g of the reader-writer 2 is selected and input from the operating unit 2d, or, is transferred from an un-illustrated database coupled with the reader-writer 2.

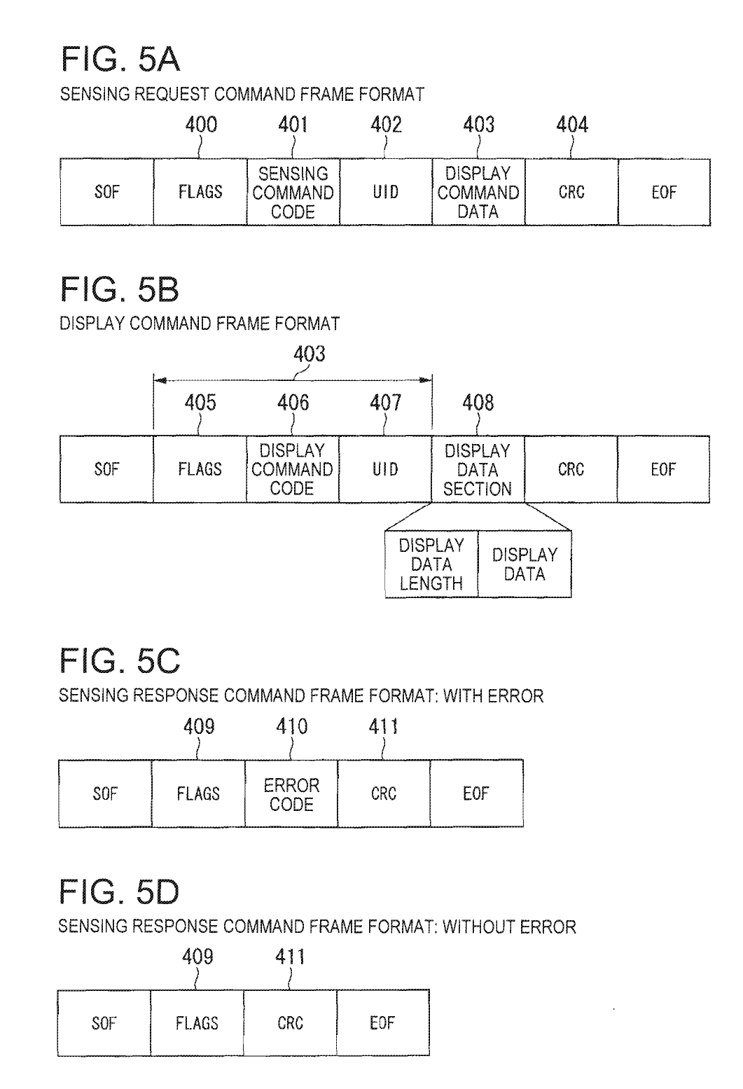

After the setting is completed, the reader-writer 2 assemble the frame of the sensing request command shown in FIG. 5A, and transmits the command to the internal tag 5 through the data transmission unit 2b. The sensing request command shown in FIG. 5A is used for: testing the solution L with the glucose sensor of the internal tag 5, so as to specify the content of the solution L at the data determination unit 34; and transmitting the result thereof to the UID set as the external tag 6, together with the data displayed in the display unit 37.

The internal tag 5, after receiving the sensing request command from the reader-writer 2, generates the drive power from the carrier wave of the signal in the power generation unlit 38, and supplies the power to each unit in the internal tag 5. Thereafter, the control unit 32 supplied with power controls the transmission of information from the reader-writer 2 through the data receiving unit 30 to the nonvolatile memory at the data storage unit 33, so as to store the information therein. Subsequently, the detection unit 35 performs the sensing of the solution L, and the data determination unit 34 specifies the content of the solution L. Finally, the internal tag 5 sets the information of the solution specified by the data determination unit 34 as a display data of the display command shown in FIG. 5B, and transmits the display data to the external tag 6 through the data transmission unit 31.

Thereafter, the external tag 6, after receiving the display command shown in FIG. 5B, generates the drive power from the carrier wave of the signal in the power generation unit 38, and supplies the power to each unit in the internal tag 6. Subsequently, the control unit 32 supplied with power controls the transmission of the information from the internal tag 5 through the data receiving unit 30 to the nonvolatile memory at the data storage unit 33, so as to store the information therein. The display data in the display command is then retrieved and goes through the display processing unit 36 so as to be displayed in the electrophoresis display of the display unit 37. At this time, no electric power is required in order to retain the display of the information, due to the characteristics of the electrophoresis display.

Finally, the external tag 6 assembles the sensing response commands shown in FIGS. 5C and 5D, and transmits the commands to the reader-writer 2 through data transmission unlit 31. Here, the reader-writer 2 does not disconnect the electromagnetic coupling with the contactless IC tag 7, after sending t he sensing request command which indicates the completion of the command processing shown in FIGS. 5C and 5D until receiving the sensing response commands.

The frame formats of each of the commands shown in FIGS. 5A to 5D will now be described.

The data communication between the reader-writer 2 and the contactless IC tag 7 is carried out in the frame format compliant with ISO/IEC18000-3 or ISO/IEC15693 as shown in FIGS. 5A to 5D.

The frame format of the sensing request command shown in FIG. 5A is formed, between the start of field (SOF) and the end of field (EOF), including a FLAGS 400, a sensing command code 401, an UID 402, a display command data 403, and a CARC 404 in that order.

The frame format of the display command shown in FIG. 5B is formed, between the SOF and the LOF, including a FLAGS 405, a display command code 406, an UID 407, and a display data 408 in that order.

The frame format of the sensing response command (with an error) shown in FIG. 5C is formed, between the SOF and the EOF, including a FLAGS 409, an error code field 410, and a CRC 411 in that order. The frame format of the sensing response command (without an error) shown in FIG. 5D is formed, between the SOF and the EOF, including the FLAGS 409 and the CRC 411 in that order.

Each frame format is not limited thereto, and may include other configuration. The frames are formed in a frame format surrounded by the SOF and the EOR The CRC includes a result of a frame calculation between the SOF and the CRC, calculated with compliance to the definition of ISO/IEC13239. FLINGS sets the functionality of the frame.

Other types of commands include commands such as a data write-in command, a tag response command, and a tag response start/end command. In the first embodiment, these commands are processed as normal commands.

The data write-in command writes in the data such as administration information into the contactless IC tag 7. The information written into the contactless IC tag 7 may be, for instance, the data which the reader-writer 2 transmits to the rewritable ROM of the data storage unit 33.

The tag response command transmits the UID of the contactless IC tag 7 to the reader-writer 2. All the contactless IC tags 7 that received this command transmit the UIDs stored therein.

The tag response start/end command is a control command for deciding whether or not to reply the information to the reader-writer 2. After receiving a command transmitted from the reader-writer 2, this command decides whether or not the contactless IC tag 7 sends back the data to the reader-writer 2 as a response to the command. If the contents of the command is set to a start state, then the contactless IC tag 7 replies and sends back the data, after receiving this command from the reader-writer 2. If the contents of the command is set to a stop state, then the contactless IC tag 7 does not respond after receiving the command from the reader-writer 2.

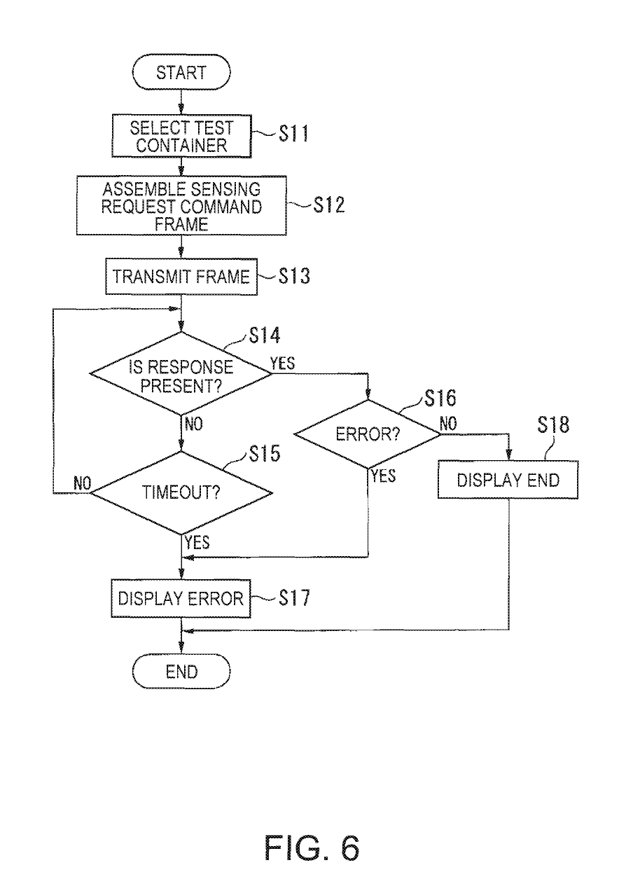

FIG. 6 is a flowchart illustrating the processing conducted by the reader-writer 2, from the moment the reader-writer 2 sends the sensing request command to the contactless IC tag 7 until receiving therefrom the response.

Table 1 enlists the names of the test containers and the UIDs of the contactless IC tags adhered to those test containers.

TABEL 1

| Test Container | Sensing Tag UID | Display Tag UID |
|---|---|---|
| A | 10H | 11H |
| B | 12H | 13H |
| . . . | . . . | . . . |

In step S11, the pre-registered test container is selected. As shown in Table 1, the test containers have the UIDs registered in ROM 2f of the reader-writer 2 as a database, including the UIDs of the internal tag 5 and the UIDs of the external tag 6, respectively serving as the sensing tag to which the glucose sensor is mounted, and as the display tag to which the display unit 37 is mounted. The container 4 is selected by moving a cursor of the operating unit 2d so as to select the test container displayed in the display unit 2g.

In step S12, a sensing request command frame shown in FIG. 5A is assembled. A display command data frame shown in FIG. 5B is included in the display command data 403 that is included inside the sensing request command frame. An UID of the sensing tag selected in step S11 is set for the UID 402. At the same time, an UID of the display tag selected in step 511 is set for the display command data 403.

In step S13, the data of the sensing request command assembled in step S12 is sent to the data transmission unit 2b, and transmitted to the contactless IC tag 7.

In step S14, the reader-writer 2 receives and analyzes a response from the contactless IC tag 7 responding to the transmitted sensing request command. A response frame is illustrated in FIG. 5C. If there is a response, the process proceeds to step S16. If no error is included in the response, then the process proceeds to step S18, displays the display content in the display unit 2g, thereafter proceeding to the end of the process. If an error is included in the response, then the process proceeds to step S17, displays the error content in the display unit 2g, thereafter proceeding to the end of the process.

If there is no response received in step S14, the process proceeds to step S15 and confirms if it is caused by the timeout. If a timeout had occurred, then the process proceeds to step S17, displays the error content in the display unit; 2g, thereafter proceeding to the end of the process. If no timeout had occurred, the process returns again to step S14 and repeat the process of confirming the response.

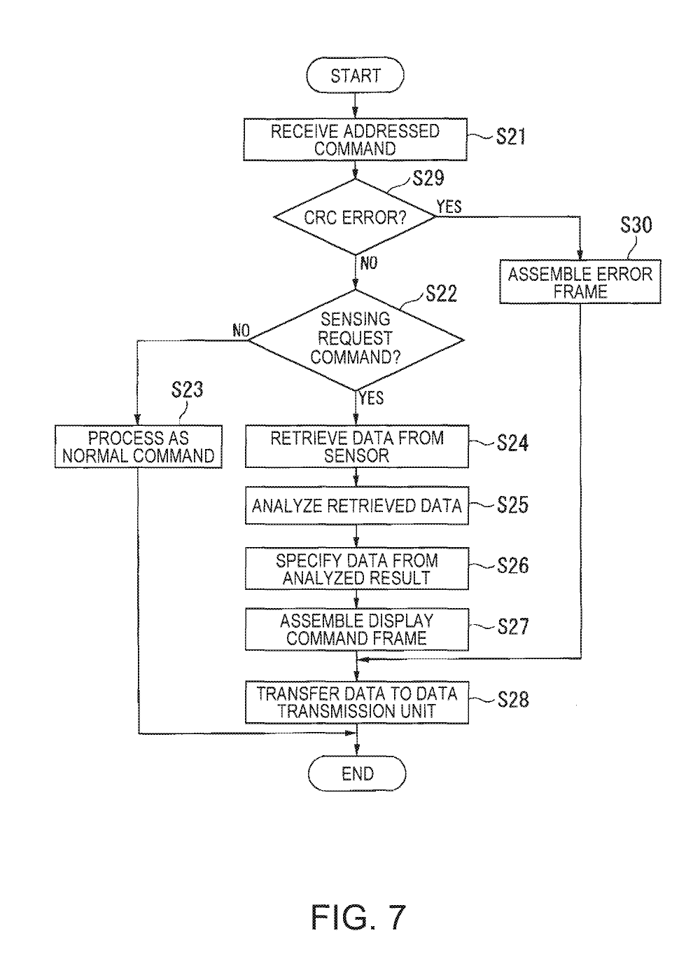

FIG. 7 is a flow chart illustrating the processing of the sensing request command within the internal tag 5 to which an enzyme sensor is mounted.

In step S21, the data receiving unit 30 receives the command sent from the reader-writer 2 addressed thereto, and thereafter the process proceeds to step S29. In step S29, the frame is checked whether or not a CRC error is included therein.

If the CRC error is found in step S29, then the process proceeds to step S30, and sets a code indicating the CRC error to an error code 410 of the sensing response command shown in FIG. 5C, followed by setting an error in the FLAGS 409, proceeding thereafter to step S28. In step S28, the sensing response command is transferred to the data transmission unit 31, so that the sensing response command is transmitted to the reader-writer 2, thereafter proceeding to the end of the process.

If no CRC error is included in the frame in step S29, the process proceeds to step S22. In step S22, the process decides whether or not the received command in step S21 is the sensing request command.

If the command is not the sensing request command, the process proceeds to step S23 where the command is processed as a normal command, proceeding afterwards to the end of the process. The normal command process complies with ISO/IEC18000-3 or ISO/IEC15693.

If the command is decided to be the sensing request command in step S22, then the process proceeds to step S24, and the control unit 32 applies a given voltage to the detection unit 35 so as to initiate the measurement. An enzyme is provided as a sensor in the detection unit 35. Enzymes reacts only to specific substances. If there is a specific substance that the enzyme reacts to, then a pulse voltage is generated from the enzyme sensor. This pulse voltage has a certain peak in its output value (voltage level). This is utilized as a sensor in order to test the presence of a specific substance.

The process proceeds to step S25 after completing step S24. In step S25, the process decides whether or not the enzyme had reacted to the specific substance, by an output voltage of the enzyme sensor, i.e., the detection unit 35. Similarly, utilizing the output voltage also applies to the case where there is a plurality of enzyme sensors provided to the detection unit 35. The process compares the output voltage of the detection unit 35 with the preset output voltage values, and analyzes if the pulse voltage is obtained, proceeding afterwards to step S26.

In step S26, if the prescribed output is obtained from the enzyme sensor of the detection unit 35, then the name of the enzyme that reacted to the specific substance is retrieved from the names stored in advance in the data storage unit 33, and is set as the display data in the display unit 37. Similarly, the display data is set for plurality of sensors. If the prescribed output is not obtained, then the display such as “no reaction” is set. After setting the display data, the process proceeds to step S27. Other display data that may be retrieved from the data storage unit 33 includes a date of purchase of the solution L, a purchaser, and an expiration date.

The process proceeds to step S27 after completing step S26. In step S27, a display command frame shown in FIG. 5B is assembled. The display command is included in a display command data section of the sensing request command. A display data 408 includes the display data set in step 826 and the display data length configured therein. When the frame is completed, the process proceeds to step S28. SOF, CRC, and EOF are calculated in the control unit 32, and are assembled into a frame.

In step S28, the internal tag 5 transfers the display command assembled in step S27 to the data transmission unit 31, so that the display command is transmitted to the external tag 6 using a load modulation signs, proceeding afterwards to the end of the process.

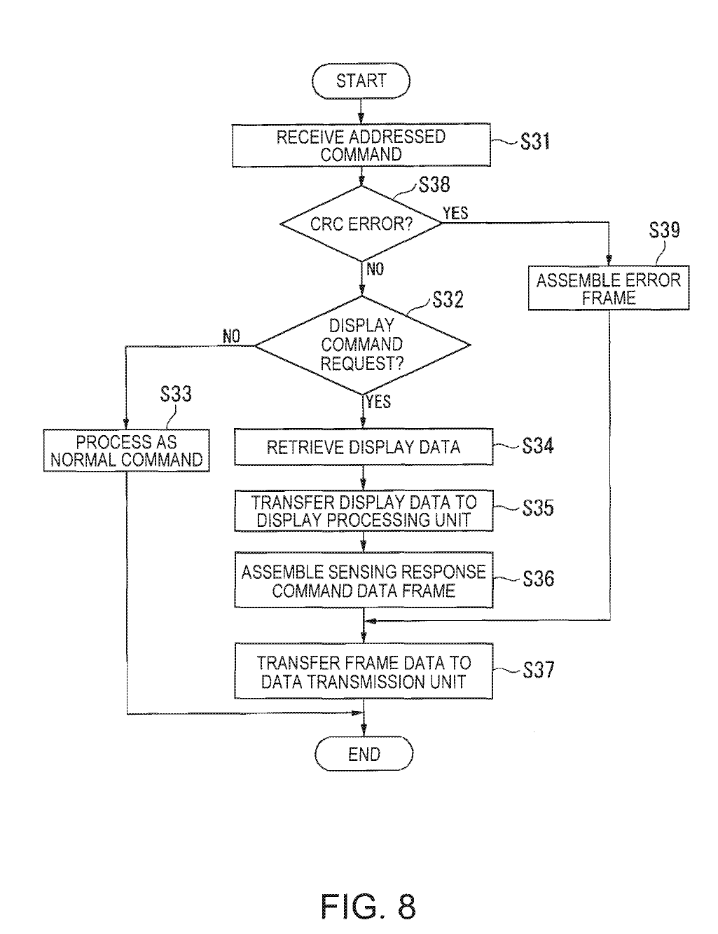

FIG. 8 is a flow chart illustrating the processing of the sensing request command carried out by the external tag 6 to which the display unit 37 is mounted.

In step S31, the external tag 6 confirms that the command is addressed thereto and receives the command, proceeding afterwards to step S38.

In step S38, the external tag 6 confirms whether or not the received command includes the CRC error. If the command includes the CRC error, then the process proceeds to step S39 so as to set the indication of the error in the error code 410 as well as in the FLAGS 409, proceeding afterwards to step S36. If no CRC error is included, the process proceeds to step S32.

In step S32, the external tag 6 confirms whether or not the received command is the display command. If the command is not the display command, the process proceeds to step S33 where the command is processed as a normal command, proceeding afterwards to the end of the process. The processing in step S33 complies with ISO/IEC18000-3 or ISO/IEC15693. If the command is the display command, the process proceeds to step S34.

In step S34, the data to be displayed in the display unit 37 is retrieved from the display data 408 within the display command illustrated in FIG. 5B, and the process proceeds to step S35. In step S35, the display data retrieved in step S34 is transferred to the display processing unit 36 so as to display the data in the display unit 37, and the process proceeds to step S36. In step S36, as shown in FIGS. 5C and 5D, the frame of the sensing response command is assembled, so to be replied to the reader-writer 2. If an error is included, the frame shown in FIG. 5C is assembled, and if no error is included, the frame shown in FIG. 5D is assembled, proceeding thereafter to step S37.

In step S37, the sensing response command assembled in step S36 is transferred to the data transmission unit 31, transmitting the data to the reader-writer 2, thereafter proceeding to the end of the process.

The contactless data communication system 1 according to the first embodiment as described above provides the following effects.
(1) The amount of the contactless IC tags discarded is minimized, by mounting the detection unit 35 and the display unit 37 on the contactless IC tag 7, so as to allow rewriting of the display without replacing the contactless IC tag 7. Moreover, the direct communication between the contactless IC tags 7 in a short range leaves out the need to form the contactless IC tags 7 with a typical structures, thereby reducing the cost thereof,
(2) The credibility of the display contents is increased by displaying the content of the solution L directly detected by the detection unit 35 of the contactless IC tag 7, thereby improving the safety of the user handing the container 4.

### Second Embodiment

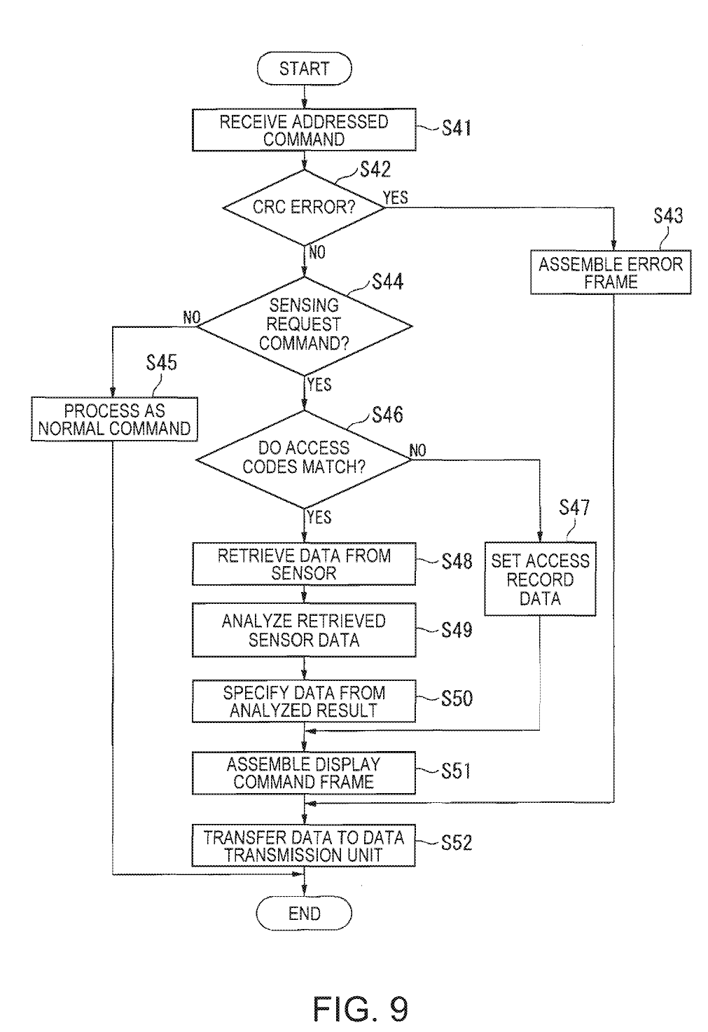

The second embodiment of the invention will now be described with references to FIG. 9.

The same signs and numerals are used for the parts equivalent to those in the first embodiment, and the description is omitted.

The contactless data communication system 1 shown as the second embodiment sets an access code from the reader-writer 2 to the contactless IC tag 7, so as to check if the access code matches the code set in advance in the contactless IC tag 7, prior to retrieving the data from the detection unit 35 serving as a sensor. If the access code does not match, the system displays the access record of the reader-writer 2 as a display data in the display unit 37. This is where the second embodiment differs from the first embodiment. The structures of the reader-writer 2 and the contactless IC tag 7 are the same as those of the first embodiment.

FIG. 9 is a flowchart illustrating the processing conducted from the moment the reader-writer 2 sends the sensing request command to the contactless IC, tag 7 until receiving therefrom the response.

FIG. 9 corresponds with the flowchart of FIG. 7 in the first embodiment described above, differing, only in step S46 and step S47. Therefore, the description is omitted for the part similar to the flowchart shown in FIG. 6.

In step S41 through step S44, the internal tag 5 receives, at the data receiving unit 30, the sensing request command from the reader-writer 2. At this time, the access record is also received (not shown), and if no CRC error is included therein, the access record is stored at the data storage unit 33.

In step S46, the access code is retrieved. The access code is set in the sensing command code 401 of the sensing request command shown in FIG. 5A. The sensing command code 401 is a single byte data, and the access code is set in the flowchart shown in FIG. 6 as the first 4 bits (not shown) of the sensing command code 401. This 4-bit access code is compared with the access code preset in the data storage unit 33 of the contactless IC tag 7. If the access codes match, then the process proceeds to step S48 in which the detection unit 35 serving as the enzyme sensor conducts the sensing. If the access codes do not match, then the access is decided to be an unauthorized access, proceeding thereafter to step S47.

In step S47, it is determined that the reader-writer 2 made the unauthorized access, and the access record is retrieved from the data storage unit 33, so as to be set as the display data 408 illustrated in FIG. 5B, proceeding afterwards to step S51. Other contents of the access records may include date, a name of the reader-writer, as well as a name of a person accessing the contactless IC tag 7. The display color may also be modified, so as to display the access record by changing the colors of characters as well as the background colors of image data and characters.

In step S51, the display command frame shown in FIG. 5B is assembled, and in step S52, this command is sent to the external tag 6 to which the display unit 37 is mounted, proceeding thereafter to the end of the process.

The contactless data communication system 1 according to the second embodiment as described above provides the following effects.
(3) The contactless IC tag 7 limits the access from the reader-writer 2 with the access code. That is to say, in case the unauthorized access occurs, the contactless IC tag 7 may access only the limited reader-writer 2. Consequently, the contactless IC tag 7 prevents the unauthorized data read-out or write-in. At the same time, the above effects prevents the user to handle the container 4 based on the incorrect information, by visualizing a purchase date, an expiry date of the solution L, and the access record of the reader-writer 2 to the contactless IC tag 7, such as a date and a name of a person or a device accessing the contactless IC tag 7, thereby increasing the safety.

What is claimed is:

1. A contactless data communication system, comprising:
a first and a second contactless integrated circuit tags each including an unique identifier;
a reader-writer for reading out and writing in data in a contactless state with the first and the second contactless integrated circuit tags;
the first integrated circuit tag including:
a data detection unit for detecting data;
a data determination unit, for determining data detected by the data detection unit; and
a data transmission unit for transmitting a determination result of the data determination unit to the second contactless integrated circuit tag;
the reader-writer and the first and the second contactless integrated circuit tags performing a contactless data communication therebetween, using an induction field; and
the first contactless integrated circuit tag creating an electrical power from the induction field generated by the reader-writer, and utilizing the electrical power so as to perform a contactless data communication with the second contactless integrated circuit tag.

2. The contactless data communication system according to claim 1,
the data detection unit including a sensor for detecting a fluid accommodated in a container, and the data determination unit determining a type of the fluid based on a data detected by the sensor.

3. The contactless data communication system according to claim 1,
the first contactless integrated circuit being arranged at an internal side of the container, and the second contactless integrated circuit tag being arranged at an external side of the container.

4. The contactless data communication system according to claim 1,
during a communication of the first contactless integrated circuit tag with the second integrated circuit tag, the reader-writer considering that a function of the second contactless integrated circuit tag is added to the first integrated circuit tag.

5. The contactless data communication system according to claim 1,
the second contactless integrated circuit tag including a data processing unit for conducting a specific processing based on data transmitted from the first contactless integrated circuit tag, the contactless data communication system being produced including the plurality of second contactless integrated circuit tags, each performing a different specific processing, and the second contactless integrated circuit tag being exchanged in accordance with the desired specific processing.

6. The contactless data communication system according to claim 1,
the second integrated circuit tag allowing a registration of unique identifiers for a plurality of first contactless integrated circuit tags, and conducting a display in the display unit, using data transmitted from the plurality of first contactless integrated circuit tags having the unique identifiers registered therein.

7. A contactless integrated circuit tag, comprising:
an unique identifier registered therein;
a reader-writer;
a data detection unit for detecting data;
a data determination unit for determining data detected by the data detection unit; and
a data transmission unit for transmitting a determination result of the data determination unit to another contactless integrated circuit tag;
the contactless integrated circuit tag creating an electrical power from an induction field generated by the reader-writer, and utilizing the electrical power so as to perform a contactless data communication with at least one of the reader/writer and another contactless integrated circuit tag.

8. A contactless integrated circuit tag, comprising:
an unique identifier registered therein;
a reader-writer;
a data receiving unit for receiving data transmitted from at least one of the reader-writer and another contactless integrated circuit tag; and
a display unit which conducts a display based on data received by the data receiving unit;
the contactless integrated circuit tag creating an electrical power from an induction field generated by the reader-writer, and utilizing the electrical power so as to perform a contactless data communication with at least one of the reader/writer and another contactless integrated circuit tag.

9. The contactless integrated circuit tag according to claim 8,
the display unit including a display device with a memory capability, retaining a display in a no-power state.
